(19) United States
(12) Patent Application Publication
(10) Pub. No.: US 2003/0014011 A1
(43) Pub. Date: Jan. 16, 2003

(54) Bypass anti-siphon valve and method

(76) Inventor: Renee Joy Robert, Shoreview, MN (US)

Correspondence Address: MERCHANT & GOULD PC, P.O. BOX 2903, MINNEAPOLIS, MN, 55402-0903, US

(21) Appl. No.: 09/905,257

(22) Filed: Jul. 12, 2001

(51) Int. Cl. F16L 37/40

(52) U.S. Cl. 604/128; 604/257; 137/601.21; 251/149.2; 251/149.3

(57) ABSTRACT

A pump system includes a pump control module and a cassette with a tube including an anti-siphon valve. A valve operates to control free flow situations, and the valve further has a bypass for priming of the system. The valve includes a bypass mechanism including at least one activation member, such as a button, which moves a movable member for disrupting the seal member of the anti-siphon valve. An alternative valve includes a separate bypass pathway around the anti-siphon valve. In this embodiment, operation of the bypass pathway does not disturb or disrupt the seal of the anti-siphon valve. Operation of the alternative bypass pathway is through a bypass mechanism including a button for movement or disruption of a bypass seal. A cap or other holder opens the bypass for each of the valves for gravity priming. A cassette includes a holder for holding an in-line anti-siphon valve with bypass in the open position, wherein the anti-siphon valve interferes with attachment of the cassette to the pump while in the holder.

### FIELD OF THE INVENTION

The present invention relates to infusion systems and methods utilizing tube sets, and pumps with removable cassettes or tube sets to deliver fluid to a patient. In particular, this invention relates to delivering fluid to a patient where the tube or conduit includes an anti-siphon valve.

### BACKGROUND OF THE INVENTION

An infusion pump provides controlled fluid delivery to a patient. An ambulatory infusion pump is shown for example in U.S. Pat. No. 5,935,099. When a cassette or tube set is used with an infusion pump, it is desirable to provide an anti-siphon control feature downstream from the pump to prevent free flow of the fluid into the patient should the pump fail or should the cassette or tube set become disconnected from the pump. In-line anti-siphon valves are known which prevent free flow, such as described in U.S. Pat. No. 4,535,820.

The in-line anti-siphon valves of the type of U.S. Pat. No. 4,535,820 require the presence of a crack pressure or threshold pressure upstream of the anti-siphon valve in order to move fluid through the tube. To prime the tube or otherwise remove air from the tube when the anti-siphon valve is in place, the caregiver or the patient must operate the pump to generate sufficient pressure to overcome the crack pressure. One option to assist with priming is to provide a separate anti-siphon valve that is added to the tube once the tube has been primed. In that situation, the tube can be gravity primed merely by holding the fluid reservoir above the downstream end of the tube. Gravity priming is advantageous in that it is often faster than priming with the pump mechanism. One problem this presents is that the caregiver or patient must add the anti-siphon valve before connecting the tube to the patient, or otherwise risk creating an opportunity for a free flow situation. There is a need for improvements in anti-siphon valves.

### SUMMARY OF THE INVENTION

A valve is provided for a tube set for use with a pump system including a pump control module and a cassette. The valve operates to control free flow situations, and the valve further has a bypass for priming of the system. The valve includes an anti-siphon valve and a bypass mechanism.

One aspect of the present invention includes at least one activation member, such as a button, which moves a movable member for disrupting the seal member of the anti-siphon valve.

A further aspect of the invention includes a separate bypass pathway around the anti-siphon valve. Operation of the bypass pathway is through a bypass mechanism including a button for movement or disruption of a bypass seal.

A cap or other holder can be used to open the bypass for each of the valves for gravity priming. In some embodiments, the cap can be placed over the outlet, and still permit gravity priming.

A cassette for use with the pump control module includes a holder for holding an in-line anti-siphon valve with bypass in the open position, wherein the valve interferes with attachment of the cassette to the pump while positioned in the holder.

### BRIEF DESCRIPTION OF THE DRAWINGS

FIG. 1 is a schematic drawing of a cassette with a remote fluid reservoir including an anti-siphon valve with bypass;

FIG. 2 is a perspective view of a prior art drug pump control module usable with the cassette of FIG. 1;

FIG. 3 is a partial cross-sectional view of an alternative control module mounted to an alternative cassette including a self-contained fluid reservoir, and an anti-siphon valve with bypass in accordance with the present invention;

FIG. 4 is a schematic drawing of a first embodiment of an anti-siphon valve with bypass, and showing a cap holding the bypass open;

FIG. 5 shows the valve of FIG. 4 with the cap removed;

FIG. 6 is a partial cutaway view of a representative cap, showing internal features of the cap;

FIG. 7 is a schematic drawing of a second embodiment of an anti-siphon valve with bypass, and showing a cap holding the bypass open;

FIG. 8 shows the valve of FIG. 7 with the cap removed;

FIG. 9 is a schematic drawing of a third embodiment of an anti-siphon valve with bypass, and showing a cap holding the bypass open;

FIG. 10 shows the valve of FIG. 9 with the cap removed;

FIG. 11 shows a perspective view of the cassette of FIG. 3, with the anti-siphon valve with bypass held by the cassette, such as for initial filling of the cassette;

FIG. 12 is a partial cross-section of a portion of the cassette and valve of FIG. 11, showing a mechanism for holding the bypass open.

### DETAILED DESCRIPTION OF THE PREFERRED EMBODIMENTS

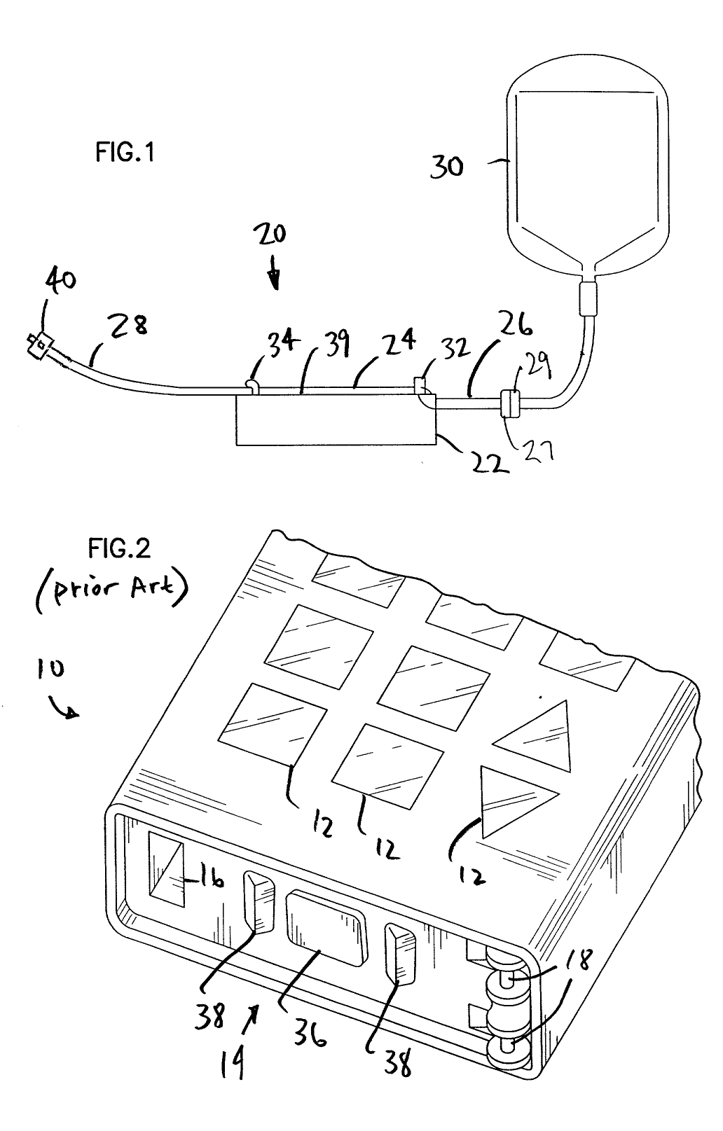

Referring now to FIGS. 1 and 2, an exemplary pump system is shown including a pump control module 10 and a cassette 20 with a tube or conduit 24 including an anti-siphon valve 40. Valve 40 operates to control free flow situations, and it further has a bypass for priming of the system.

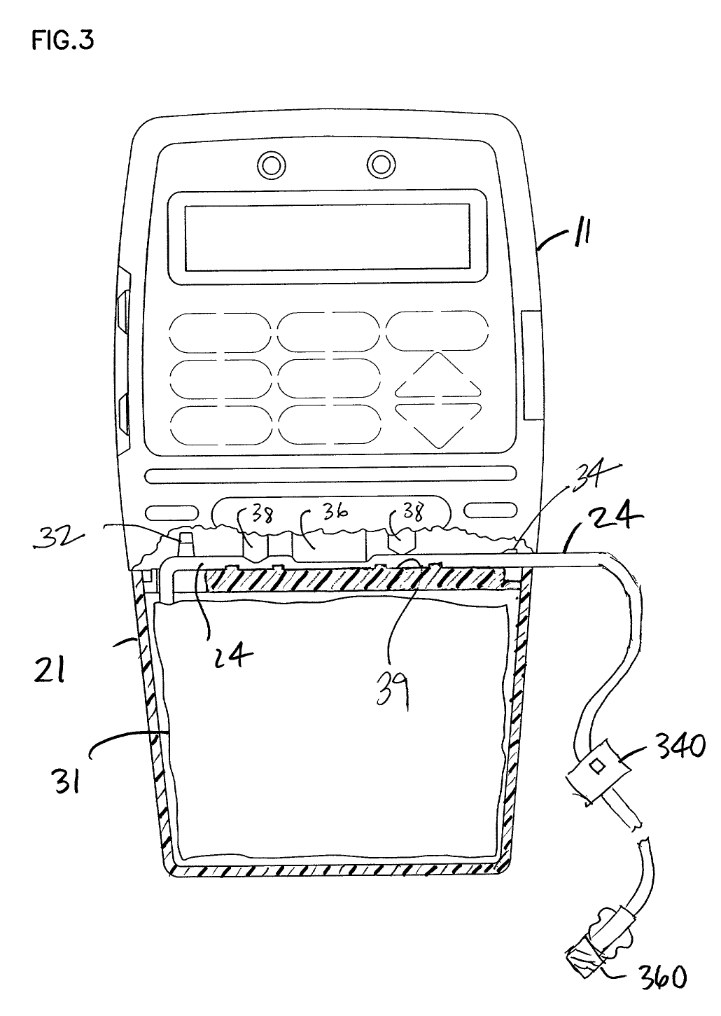

Cassette 20 includes a base plate 22 mountable to pump control module 10 for pumping fluid to a patient from a reservoir 30. Cassette 20 may also be referred to as a remote reservoir adapter. The present invention relates to cassettes specifically usable with pump control module 10, like cassette 20, and other cassettes and tube sets usable with other infusion pumps with or without base plates 22. The cassette 20 can be a self-contained cassette 21, with an inner fluid reservoir 31 as shown in FIG. 3 mounted to a further control module 11. Further details of an example infusion pump are shown in U.S. Pat. No. 5,935,099, the disclosure of which is incorporated by reference.

The valve 40 of the present invention can also be used with tube sets used with other infusion systems. For example, in some pumps, the pump includes a movable door for receipt of the tube set. The valve 40 of the present invention is useful in a variety of situations where anti-siphon protection is desired, and also a bypass function is desired.

Cassette 20 includes flexible conduit 24 connected to the cassette and having an upstream end 26 and a downstream end 28. Downstream end 28 is connectable to the patient. Fluid reservoir or bag 30 is positioned at upstream end 26 through mating connectors 27, 29. At downstream end 28, anti-siphon valve 40 is preferably permanently mounted to an end of the conduit. Such mounting can be through solvent bonding or other techniques. Further conduit is attached to valve 40, such as with a mating connector to connect to the patient.

Pump control module 10 includes a control system and a plurality of control keys 12 for controlling operation of the pumping mechanism 14. Pump control module 10 includes an internal latch 16 and two posts 18 for cooperating with loop 32 and hooks 34, respectively of cassette 20 to mount cassette 20 to control module 10. Pump mechanism 14 includes a reciprocating expulsor 36 and two reciprocating valves 38 for engaging the conduit 24 adjacent a top surface 39 of cassette 20. The pump mechanism 14 acts on conduit 24 to move fluid through conduit 24 from the bag 30 past valve 40 to the patient.

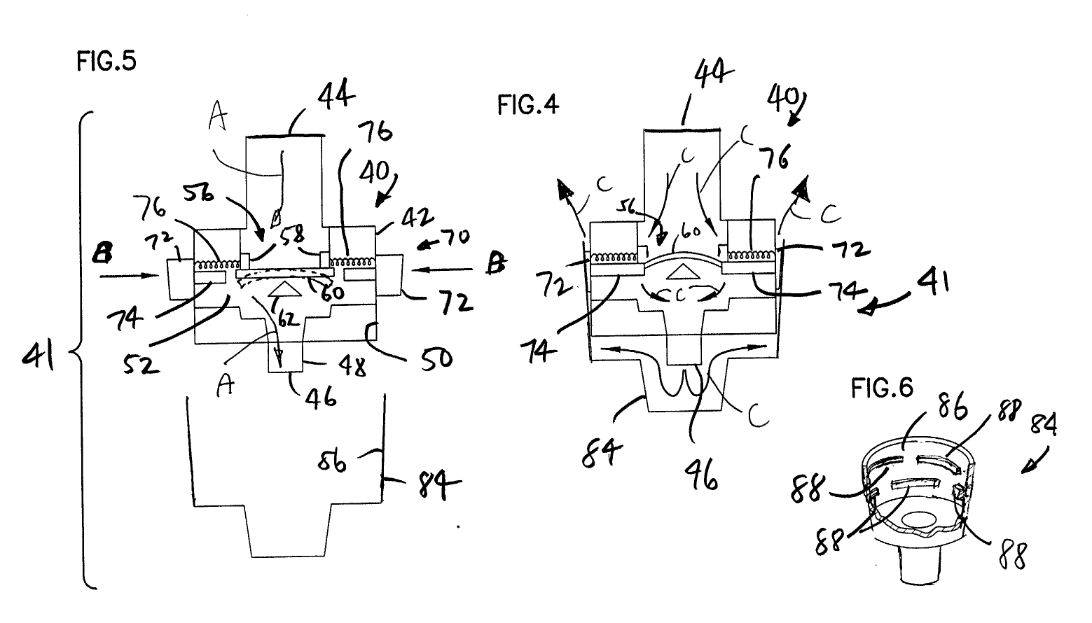

Referring now to FIGS. 4 and 5, valve 40 includes a housing 42 extending between an upstream end 44 defining an inlet and a downstream end 46 defining an outlet. Upstream end 44 is solvent bonded or otherwise attached to conduit 24. Downstream end 46 can be provided with any convenient connection structure, such as a mating Luer construction, or tube bond joint. In the illustrated valve of FIGS. 4 and 5, downstream end 46 is a male Luer end including a male Luer tip 48 and a threaded inner ring 50. A female Luer end could also be used.

Housing 42 includes an inner chamber 52 which houses an anti-siphon valve assembly 56. Anti-siphon valve assembly 56 includes a front seal support 58, a flexible disc-like seal member 60, and a rear central support 62. Various anti-siphon valve designs can be used, such as the design disclosed in U.S. Pat. No. 4,535,820, the disclosure of which is herein incorporated by reference. Generally, anti-siphon valve assembly 56 allows fluid flow when a threshold or crack pressure is exceeded, such as due to operation of the pump. Anti-siphon valve assembly 56 prevents free flow should the fluid reservoir be positioned above the patient, and the cassette or base plate is not attached properly to the pump. Before the crack pressure is exceeded, the seal member 60 seals against front seal support 58, as shown in FIG. 5. When the crack pressure is exceeded, seal member 60 bends at its periphery relative to its center around rear support 62 (See dashed lines in FIG. 5), thereby allowing fluid flow past valve 40 in the direction of arrows A. Flow in the opposite direction is prevented by valve assembly 56.

Valve 40 includes a bypass mechanism 70 including at least one activation member 72, such as a button which moves a movable member 74 such as a rod for disrupting the seal member 60 relative to front seal support 58. Button 72 is exposed on an exterior of valve 40. A spring 76 biases movable member 74 to a non-interfering position, or closed position as shown in FIG. 5. Once button 72 is pressed, or both buttons 72 in the case of FIG. 5, in the direction of arrows B, movable members 74 engage seal member 60, thereby disrupting the seal at front seal support 58, and allowing for passage of air and/or fluid through anti-siphon valve assembly 56 in the direction of arrows C. FIG. 4 shows both buttons 72 pushed. Once buttons 72 are released, the springs 76 move the movable members 74 back to the non-interfering position.

The buttons 72 can be held by hand (for example, a finger and a thumb) or by a holder. To assist with initial priming and removal of air, a cap 84 is provided for fitting over an exterior of housing 42. Cap 84 includes an inner sidewall 86 which receives housing 42 along an outer periphery of housing 42. As shown in FIG. 4, sidewall 86 engages buttons 72, thereby holding the bypass mechanism in the open position, and allowing fluid and/or air flow. Cap 84 does not seal the outlet 46. Preferred cap 84 includes staggered bumps or ridges 88 which create a tortuous path to an exterior of the valve and cap combination 41. The tortuous path is preferred for preventing dust and other impurities from migrating into cap 84 and into valve 40. However, the tortuous path allows for the flow of air or fluid, so as to allow gravity priming. Once cap 84 is removed, springs 76 return movable members 74 to the closed position, as shown in FIG. 5.

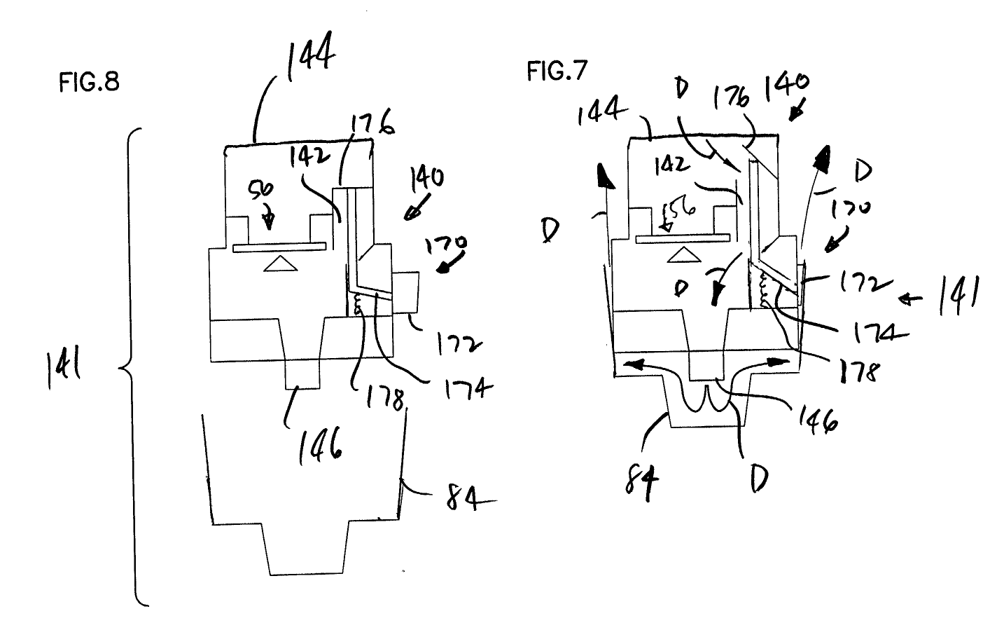

Referring now to FIGS. 7 and 8, a second embodiment of a valve 140 is shown. Valve 140 includes a separate bypass pathway 142 around anti-siphon valve 56 between inlet 144 and outlet 146. In this embodiment, operation of the bypass pathway does not disturb or disrupt the seal of the anti-siphon valve. Operation of the bypass pathway is through a bypass mechanism 170 including a button 172, connected to a linkage 174 for movement of a door 176. Once activated, air or fluid can be moved in the direction of arrows D to prime the conduit. A spring 178 returns linkage 174 and door 176 to the closed position as shown in FIG. 8. As with valve 40, a cap 84 is provided for placement over valve 140, to form valve and cap combination 141 to hold the bypass open to allow for initial gravity priming.

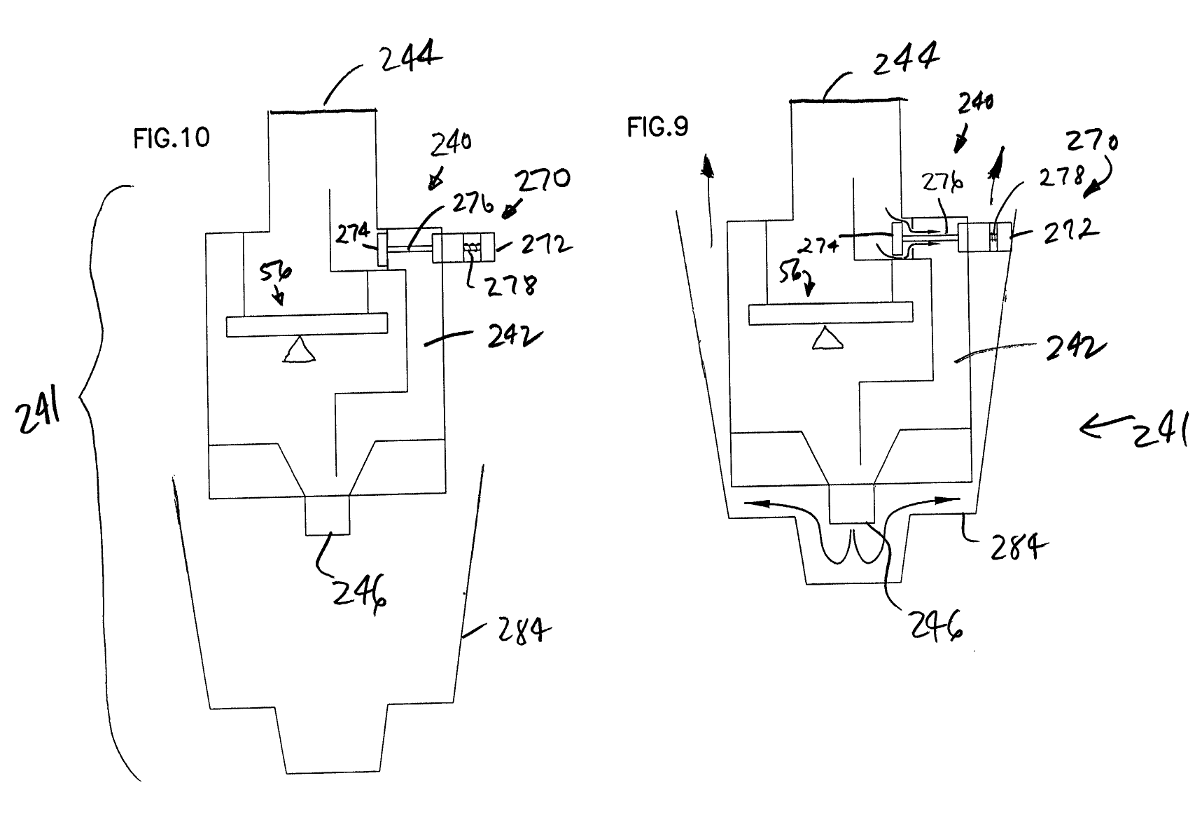

Referring now to FIGS. 9 and 10, a third embodiment of a valve 240 is shown with an inlet 244 and an outlet 246. Like valve 140, a bypass pathway 242 is provided to bypass anti-siphon valve 56. A bypass mechanism 270 operates bypass pathway 242 and includes a button 272 and a movable plunger 274 connected to the button through a shaft 276. A spring 278 biases plunger 274, shaft 276, and button 272 to the closed position as shown in FIG. 10. In a similar manner, a cap 284 is provided to form valve and cap combination 241 to hold bypass mechanism 270 in the open position, for initial gravity priming.

With caps 84, 284, valves 40, 140, 240 can be sold and shipped so that each is pre-configured into the open or bypassed state. The caregiver or patient can conduct a gravity prime without activating any device or button. Once the priming operation is completed, the caregiver or patient removes the cap which reactivates or closes the bypass. The cap is preferably not configured to fit any conduit connection structure, such as Luer, for connecting to downstream conduit leading to the patient. With this mechanical non-fit feature, the cap cannot be overlooked before pumping to the patient can begin. The cap is removed to gain access to the connection structure, Luer in the embodiments shown, thereby automatically closing the bypass.

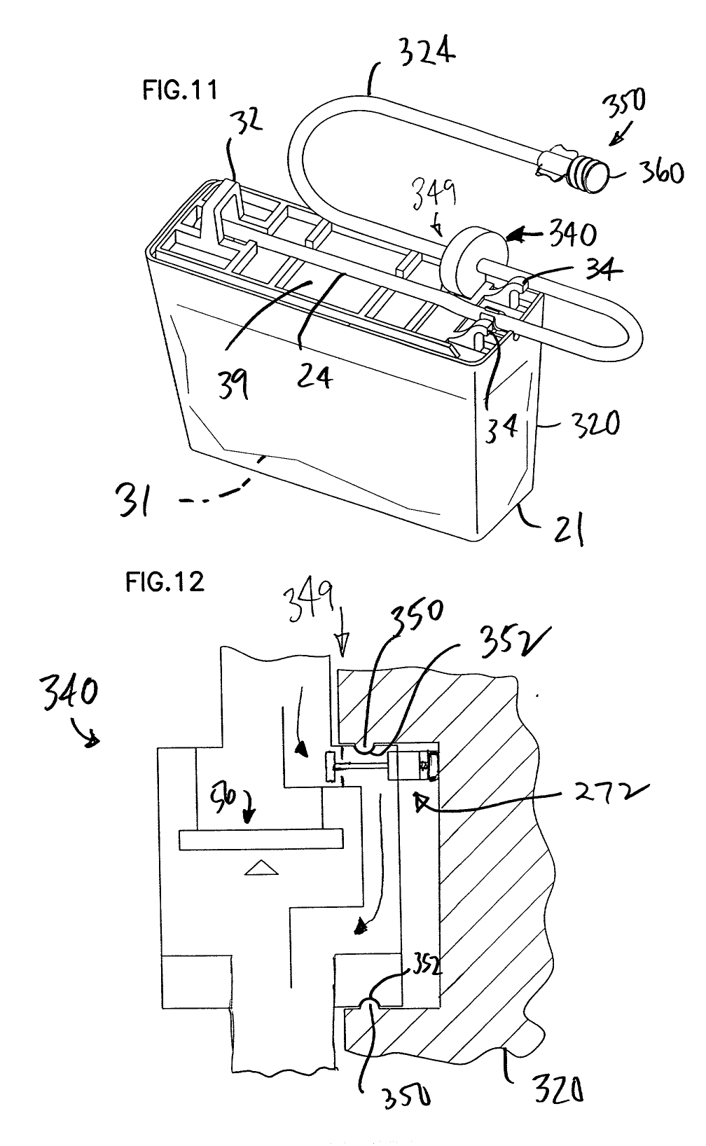

Referring now to FIGS. 11 and 12, a fourth embodiment of an anti-siphon valve 340 is shown mounted in line in the conduit, but not positioned at an accessible distal end. Valve 340 is positioned so that engagement with a cap over an end is not possible due to the downstream conduit. Valve 340 has similar interior structure to valve 240. A first conduit 24 leads to valve 340. A second conduit 324 downstream of valve 340 is also connected to valve 340. Preferably, valve 340 is permanently connected to both of conduits 24, 324. The bypass function of valve 340 can be used for priming of the conduit. The bypass is also used for initial filling of the reservoir in the cassette. Without the bypass, the anti-siphon valve assembly 56 would not allow the backflow required for filling through the outlet tube. The distal end of conduit 324 includes a connector 360, such as a conventional female Luer connector.

Valve 340 is put into the open state to allow filling. Valve 340 is held in the open or bypass position by hand or by selectively attaching valve 340 to a holder. One preferred holder can be incorporated into cassette housing 320. One example holder or retention mechanism 349 includes tabs 350 and recesses 352 between the cassette 21 and the valve 340. Due to the resilient properties of the cassette and valve (plastic construction), the valve 340 snaps into place. The holder relieves the caregiver from having to hold the bypass button manually. While the valve is positioned adjacent a top surface of cassette 320, as shown in FIG. 11, it is not possible to mount the cassette to the pump control module in the position shown. Therefore, the caregiver must remove the valve 340 from the holder, thereby allowing automatic reactivation or closure of the bypass mechanism before pumping to the patient can begin.

The above specification and examples provide a complete description of the invention. Since many embodiments of the invention can be made without departing from the spirit and scope of the invention, the invention resides in the claims hereinafter appended.

What is claimed is:

1. A valve comprising:
an anti-siphon valve including an inlet, an outlet, and a seal positioned within the valve between the inlet and the outlet to allow one-way fluid flow between the inlet and the outlet at a fluid pressure above a crack pressure;
a bypass mechanism including a movable member biased to a closed position away from contact with the seal of the anti-siphon valve, the movable member movable to an open position in contact with the seal of the anti-siphon valve to prevent the formation of a seal between the inlet and the outlet, wherein the bypass mechanism includes a moveable activation member on an exterior of the anti-siphon valve.

2. The valve of claim 1, further comprising a flexible conduit for delivering fluid, the inlet permanently connected to the conduit.

3. The valve of claim 2, further comprising a cap positioned over the outlet and engaged with the activation member of the bypass mechanism to hold the movable member in the open position.

4. The valve of claim 3, wherein the cap includes a plurality of ridges disposed on an inner surface of the cap engaged with an exterior surface of the anti-siphon valve.

5. A valve comprising:
an anti-siphon valve including an inlet, an outlet, and a seal positioned within the valve between the inlet and the outlet to allow one-way fluid flow between the inlet and the outlet at a fluid pressure above a crack pressure;
a bypass pathway within the valve linking the inlet to the outlet and bypassing the seal of the anti-siphon valve without disrupting the seal;
a bypass seal positioned in the bypass pathway to selectively seal the bypass pathway, wherein the bypass seal is movable between a sealed position and an unsealed position;
a bypass mechanism for moving the bypass seal between sealed and unsealed positions.

6. The valve of claim 5, further comprising a flexible conduit for delivering fluid, the inlet permanently connected to the conduit.

7. The valve of claim 6, wherein the bypass mechanism includes a movable member biased to a closed position, and movable to an open position for moving the bypass seal from the sealed to the unsealed position, wherein the bypass mechanism includes a moveable activation member on an exterior of the anti-siphon valve.

8. The valve of claim 7, further comprising a cap positioned over the outlet and engageable with the activation member of the bypass mechanism to hold the bypass mechanism in the open position.

9. The valve of claim 8, wherein the cap includes a plurality of ridges disposed on an inner surface of the cap engageable with an exterior surface of the anti-siphon valve.

10. The valve of claim 5, wherein the bypass mechanism includes a movable member biased to a closed position, and movable to an open position for moving the bypass seal from the sealed to the unsealed position, wherein the bypass mechanism includes a moveable activation member on an exterior of the anti-siphon valve.

11. A tube set comprising:
a flexible conduit for delivering fluid;
an anti-siphon valve including an inlet permanently connected to the conduit, an outlet, and a seal positioned within the valve between the inlet and the outlet to allow one-way fluid flow between the inlet and the outlet at a fluid pressure above a crack pressure;
a bypass mechanism for allowing free flow when the bypass mechanism is moved from a closed position to an open position, the bypass mechanism biased to the closed position, and operable through an activation member;
a cap positioned over the outlet to engage the activation member and hold the bypass mechanism in the open position.

12. The tube set of claim 11, wherein the cap includes a plurality of ridges disposed on an inner surface of the cap engageable with an exterior surface of the anti-siphon valve.

13. A method of pumping fluid through a tube set comprising the steps of:
providing a fluid conduit with a distal end having an anti-siphon valve permanently mounted to the distal end of the conduit;
moving a movable member on the anti-siphon valve by engaging an exterior surface of the anti-siphon valve, wherein the movable member moves against a bias force to disrupt a seal member of the anti-siphon valve
resealing the seal member of the anti-siphon valve;
pumping fluid through the anti-siphon valve to a patient from a pump.

14. A method of pumping fluid through a tube set comprising the steps of:
providing a fluid conduit with a distal end having an anti-siphon valve permanently mounted to the distal end of the conduit;
moving a movable member to open a bypass pathway around the sealed anti-siphon valve;
resealing the bypass pathway;
pumping fluid through the anti-siphon valve to a patient from a pump.

15. A method of pumping fluid through a tube set comprising the steps of:
providing a fluid conduit with a distal end having an anti-siphon valve permanently mounted to the distal end of the conduit;
providing a cap on an outlet of the anti-siphon valve;
connecting the conduit to a pump;
priming the conduit by removing air through the outlet with the cap positioned on the outlet;
removing the cap from the end of the primed conduit.

16. A cassette comprising:
a cassette housing attachable to a pump control module, the cassette housing including a top surface;
a flexible conduit positioned along the top surface;
an anti-siphon valve including an inlet permanently connected to the conduit, an outlet, and a seal positioned within the valve between the inlet and the outlet to allow one-way fluid flow between the inlet and the outlet at a fluid pressure above a crack pressure;
a bypass mechanism for allowing free flow when the bypass mechanism is moved from a closed position to an open position, the bypass mechanism biased to the closed position, and operable through an activation member;
the top surface defining a holder for the anti-siphon valve, the holder engageable with the activation member to hold the bypass mechanism in the open position.

17. The cassette of claim 16, further comprising a downstream conduit permanently connected to the outlet of the anti-siphon valve.

18. A method of filling a cassette providing the steps of:
providing a cassette including an in-line anti-siphon valve permanently connected between an upstream flexible conduit and a downstream flexible conduit;
mounting the anti-siphon valve to a top surface of the cassette, wherein the cassette holds a bypass mechanism in an open position to allow free flow through the anti-siphon valve;
filling a fluid reservoir with fluid disposed in an interior chamber of the cassette and connected to the upstream flexible conduit by filling the fluid through the downstream flexible conduit, the anti-siphon valve, and the upstream flexible conduit and into the fluid reservoir.
